(19) United States
(12) Patent Application Publication
(10) Pub. No.: US 2007/0115421 A1
(43) Pub. Date: May 24, 2007

(54) COLOR FILTER SUBSTRATE, LIQUID CRYSTAL DISPLAY, AND ELECTRONIC DEVICE, AND METHOD FOR MANUFACTURING COLOR FILTER SUBSTRATE AND METHOD FOR MANUFACTURING LIQUID CRYSTAL DISPLAY

(75) Inventor: Toshiyuki NONAKA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/556,405

(22) Filed: Nov. 3, 2006

(30) Foreign Application Priority Data
Nov. 24, 2005 (JP) 2005-338280

(51) Int. Cl. G02F 1/1339

(52) U.S. Cl. 349/156

(57) ABSTRACT

A color filer substrate composing a liquid crystal display by sandwiching a liquid crystal with an opposite substrate having a plurality of pixel electrodes includes a first partition wall surrounding a plurality of color element areas on the color filter substrate, a second partition wall partitioning each of the plurality of color element areas into a plurality of areas, and plural types of color elements formed in the plurality of color element areas, wherein the second partition wall is formed so as to protrude further than the color element and the protruding portion also serves as a protrusion for controlling the orientation of a molecule of the liquid crystal.

### BACKGROUND

1. Technical Field

The present invention relates to a color filter substrate having a protrusion for orientation control, a liquid crystal display and an electronic device having such a color filter substrate, and a method for manufacturing a color filter substrate and a method for manufacturing a liquid crystal display.

2. Related Art

JP-A-2003-35905 discloses on pages four and five that, as a color filter substrate having a protrusion for orientation control, known is a color filter in which the protrusion having electrical properties of a specific inductive capacity of 11 or less and an electrical conductivity of 3×10⁻¹²S/cm or more is formed on a common transparent electrode covering a colored layer. According to this disclosure (first disclosure), the colored layer on which the protrusion is provided is formed by pigment dispersion using a photosensitive resin containing a desired coloring material as well as by printing, electric disposition, transfer, and the like.

Further, according to the first disclosure, the protrusion can be formed by photolithography using a negative photosensitive resin or a positive photosensitive resin containing a conductive powder as an ingredient.

Further, according to the first disclosure, an MVA (Multi-domain Vertical Alignment) liquid crystal display having such a color filter less likely causes an image retention phenomenon due to deflection of an ion in a liquid crystal cell or accumulation of electrical charge on an interface between an orientation film and a liquid crystal.

JP-A-2003-66222 discloses on pages two to three that, as a method for manufacturing a color filter substrate having plural types of colored layers (color elements) thereon, there is the inkjet method in which a plurality of color forming portions (color element areas) surrounded by a partition wall is formed on a substrate, and a coloring ink is ejected onto the color forming portions and then dried at a predetermined temperature to form a colored layer.

Rcently an MVA mode liquid crystal display is used in a color TV set and its screen size has become increasingly larger. Consequently the size of a color filter substrate used in such a display has also become larger. This causes a problem that many laborious process steps, such as coating to a substrate, exposure, development, and washing of a photosensitive resin, as well as a large-scale facility corresponding to such a large substrate are required to form a colored layer or a protrusion for orientation control by photolithography.

The abovementioned known color filter has a protrusion for orientation control formed on the formed colored layer. For this reason, there is a problem that a colored layer beneath the protrusion is not used for actual display, wasting a material forming such a colored layer.

To solve this problem, it is conceivable to form not only a color layer but also a protrusion using the inkjet method. However, the width of the protrusion is approximately 5 to 10 micrometers. There has been disclosed no problem solving means by which such a minute pattern can be formed by the inkjet method.

Even in the abovementioned known art by which a colored layer is formed by the inkjet method, as the size of a pixel of a liquid crystal display becomes larger and the frequency of ejecting a coloring ink onto the corresponding color forming portion is increased, it is difficult to fill the corner sections of the pixel with the coloring ink, causing a so-called “dropout” phenomenon. This known art also has a problem that it is difficult to secure evenness of the surface of the colored layer.

### SUMMARY

An advantage of the invention is to provide a color filter substrate having the manufacturing process of a protrusion for orientation control that can be simplified and having uniform color elements in a color element area, a liquid crystal display and an electronic device, and a method for manufacturing a color filter substrate and a method for manufacturing a liquid crystal display.

According to a first aspect of the invention, a color filer substrate composing a liquid crystal display by sandwiching a liquid crystal with an opposite substrate having a plurality of pixel electrodes includes a first partition wall surrounding a plurality of color element areas on the color filter substrate, a second partition wall partitioning each of the plurality of color element areas into a plurality of areas, and plural types of color elements formed in the plurality of color element areas, wherein the second partition wall is formed so as to protrude further than the color element and the protruding portion also serves as a protrusion for controlling the orientation of a molecule of the liquid crystal.

According to this aspect, the second partition wall is formed so as to protrude further than the color elements, and the protruding portion also serves as a protrusion for controlling the orientation of a molecule of a liquid crystal. Therefore, there is no need for a step of forming a protrusion for sole use, allowing simplification of the manufacturing process. The second partition wall is provided so as to partition the color element area, surrounded by the first partition wall, into a plurality of areas. Therefore, unlike in a case in which the second partition wall is not provided, it is possible to form color elements on each plurality of areas, which are formed by partitioning the color element area and are made narrower than the color element area. This makes it easy to even a color element to be formed. Particularly, for a color filter substrate used in a large-scale liquid crystal display, even though a color element area is partitioned into a plurality of areas by the second partition wall, the display is less affected by the second partition wall since a color element area corresponding to a display pixel is large in size. Therefore, it is possible to provide a color filter substrate having the manufacturing process of a protrusion for orientation control that can be simplified and having uniform color elements in a color element area. In addition, since the area in which color elements are formed is reduced by providing the second partition wall, it is possible to reduce the consumption of the color element forming material.

It is preferable that the color element be formed by ejecting a function liquid including a color element forming material onto the color element area. According to this aspect, since the color element area is surrounded by the first partition wall and is partitioned into a plurality of areas by the second partition wall, when a function liquid including a color element forming material is ejected onto each plurality of areas that are formed by partitioning the color element area and are made narrower than the color element area, it is possible to fill each plurality of areas with the function liquid, forming color elements having a uniform film thickness as well as evenness. That is, it is possible to reduce dropout faults of forming no color element partially and thus to provide a color filter substrate that has more uniform color elements in the color element area.

It is preferable that the second partition wall be formed so as to be 1 to 2 micrometers higher than the first partition wall and the color element has approximately the same film thickness as that of the first partition wall. According to this aspect, since the second partition wall is 1 to 2 micrometers higher than the first partition wall and the color element has approximately the same film thickness as that of the first partition wall, when an orientation film for vertical orientation is formed so as to cover the substrate surface, it is possible to partition the color element area into a plurality of areas in which the orientation is controlled, using the second partition wall as a border, without generating unevenness toward the orientation film surface on the border between the first partition wall and the color element.

It is preferable that the top of the second partition wall be curved. According to this aspect, since the top of the second partition wall is curved, the second partition wall can also serves as a protrusion for orientation control that makes the orientation change mildly using the top as a border.

According to the second aspect of the invention, a liquid crystal display includes the color filter substrate according to the first aspect of the invention, an opposite substrate having a plurality of pixel electrodes corresponding to the plurality of color element areas on the color filter substrate, and a liquid crystal sandwiched between the color filter substrate and the opposite substrate. In this case, the respective surfaces of the color filter substrate and the opposite substrate facing the liquid crystal may be provided with an orientation film for orienting a molecule of the liquid crystal approximately perpendicularly to the respective surfaces.

This configuration includes a color filter substrate having the manufacturing process of a protrusion for orientation control that can be simplified and having uniform color elements in the color element area. This makes it possible to provide an MVA liquid crystal display that has high cost-performance as well as high display quality of less display faults such as dropout and color unevenness.

It is preferable that the pixel electrode be provided with an aperture opening toward the color filter substrate in parallel with the second partition wall in positions corresponding to the plurality of areas formed by partitioning each of the plurality of color element areas by the second partition wall. The viewing angle characteristics of a liquid crystal display depend on the orientation of a molecule of the liquid crystal while the molecule is driven. According to this configuration, the molecule of the liquid crystal falls toward the aperture provided on the pixel electrode when a drive voltage is applied, using the second partition wall that also serves as a protrusion for orientation control as a border. This makes it possible to form orientation controlling areas with different viewing angle characteristics on a display area provided with the pixel electrode using the second partition wall as a border, thus providing an MVA liquid crystal display having a wide viewing angle.

According to the third aspect of the invention, an electronic device has any one of the abovementioned liquid crystal displays installed thereon. According to this configuration, since an MVA liquid crystal display that has high cost-performance as well as high display quality is installed, it is possible to provide an electronic device that has excellent display quality and cost-competitiveness.

According to the fourth aspect of the invention, a method for manufacturing a color filter substrate having plural types of color elements in a plurality of color element areas surrounded on a substrate includes forming a first partition wall so that the first partition wall surrounds the plurality of color element areas on the substrate, forming a second partition wall so that the second partition wall partitions each of the plurality of color element areas into a plurality of areas, and forming plural types of color elements by ejecting plural types of function liquids including different color element forming materials onto the plurality of color element areas. In this case, in the second partition wall forming step, the second partition wall may be formed so as to protrude further than the first partition wall in the height direction.

According to this method, in the second partition wall forming step, the second partition wall is formed so as to partition a color element area into a plurality of areas as well as to protrude further than the first partition wall in the height direction. Therefore, it is possible to make the second partition wall serve as a protrusion for orientation control. In the color element forming step, plural types of color elements are formed by ejecting plural types of function liquids including different color element forming materials onto a color element area that is partitioned into plurality of areas. Therefore, since the color elements are formed by ejecting the function liquids onto each plurality of areas that are formed by partitioning the color element area by the second partition wall and made narrower than the color element area, it is possible to fill each plurality of areas with the function liquids, forming uniform color elements. That is, it is possible to simplify the manufacturing process and to manufacture a color filter substrate having uniform color elements, by forming the second partition such that the second partition wall serves as a protrusion for orientation control. Such a method for manufacturing a color filter substrate is particularly preferable as a method for manufacturing a color filter substrate to be used in an MVA liquid crystal display whose pixel size, i.e., color element area size is large.

It is preferable that in the color element forming step, the function liquids are ejected so that the first partition wall and the color elements have approximately the same film thickness. According to the abovementioned method, it is possible to reduce the likelihood of generating unevenness in height between the first partition wall and the color elements. By forming an orientation film on the surface of a color filter substrate manufactured by this method, it is possible to manufacture a color filter substrate that is less likely to generate a disparity in orientation due to unevenness in height between the first partition wall and the color elements.

It is preferable that the method for manufacturing a color filter substrate further include applying liquid repellent treatment to the substrate surface so that the substrate surface is liquid repellent, and applying lyophilic treatment to the substrate surface subjected to liquid repellent treatment, corresponding to an area in which the first partition wall is formed and an area in which the second partition wall is formed, so that such a substrate is lyophilic. In this case, in the first partition wall forming step and the second partition wall forming step, the first partition wall and the second partition wall may be formed by ejecting a function liquid including a partition wall forming material onto the substrate surface subjected to lyophilic treatment.

According to this method, in the liquid repellent treatment step, the substrate surface is previously subjected to liquid repellent treatment, and in the lyophilic treatment step, the areas in which the first partition wall and the second partition wall are formed are subjected to lyophilic treatment. Therefore, in the first partition wall forming step and the second partition wall forming step, when ejecting a function liquid including a partition wall forming material, the function liquid wets, and spreads on, the substrate surface subjected to lyophilic treatment, but not the substrate surface subjected to liquid repellent treatment. This makes it possible to form the first partition wall so that the first partition wall surrounds the color element areas. This also makes it possible to form the second partition wall so that the second partition wall partitions the color element area into a plurality of areas.

It is preferable that the method for manufacturing a color filter substrate further include applying liquid repellent treatment to the substrate surface on which the first partition is formed so that such a surface is liquid repellent, and applying lyophilic treatment to the substrate surface subjected to liquid repellent treatment, corresponding to the area in which the second partition wall is formed, so that such a surface is lyophilic. In this case, in the second partition wall forming step, the second partition wall may be formed by ejecting a function liquid including a partition wall forming material onto the substrate surface subjected to lyophilic treatment. According to this method, the first partition wall is first formed on the substrate surface and then the liquid repellent treatment is applied. In the second partition wall forming step, a function liquid is ejected onto the substrate surface subjected to lyophilic treatment to form the second partition wall. Therefore, when forming the first partition wall, for example, by photolithography, it is possible to surround the color element areas by the first partition wall in a more stable shape. Further, it is possible to form the second partition wall that serves as a protrusion for orientation control by the function liquid ejecting method.

In these methods for manufacturing a color filter substrate according to the invention, it is preferable that the liquid repellent treatment step include a step of forming a liquid repellent thin film on the substrate surface and that the color element forming step include a step of eliminating at least the thin film remaining in the color element area. According to the abovementioned method, when the thin film remaining in the color element area is eliminated and then a function liquid including a color element forming material lands on the color element area, it is possible for the function liquid to easily wet, and spread on, the color element area. That is, it is possible to form more uniform color elements by filling the color element area with the function liquid.

In these methods for manufacturing a color filter substrate according to the invention, it is preferable that in the lyophilic treatment step, at least the substrate surface subjected to liquid repellent treatment, corresponding to an area in which the second partition wall is formed, is irradiated with a ray so as to be lyophilic. According to the abovementioned method, it is possible to quickly and highly precisely make the area in which the second partition wall is formed lyophilic.

According to the fifth aspect of the invention, a method for manufacturing a liquid crystal display including a color filter substrate having plural types of color elements, an opposite substrate having a plurality of pixel electrodes corresponding to the plural types of color elements, a liquid crystal sandwiched between the color filter substrate and the opposite substrate, and an orientation film provided on the respective surfaces of the color filter substrate and the opposite substrate facing the liquid crystal for orienting a molecule of the liquid crystal approximately perpendicularly to the respective surfaces. In this case, the color filter substrate may be manufactured using the abovementioned methods for manufacturing a color filter substrate according to the invention.

According to this method, it is possible to simplify the manufacturing process by forming the second partition wall so as to serve as a protrusion for orientation control as well as to manufacture an MVA liquid crystal display with efficiency and increased yield in which faults such as dropout and color unevenness are reduced, owing to use of a method for manufacturing a color filter substrate in which uniform color elements can be formed.

### BRIEF DESCRIPTION OF THE DRAWINGS

The invention will be described with reference to the accompanying drawings, wherein like numbers reference like elements.

FIG. 1 is a plane view schematically showing the structure of a color filter substrate.

FIG. 2 is an enlarged plane view showing one color element area.

FIG. 3 shows a schematic A-A cross-section of the color element area shown in FIG. 2.

FIG. 4 is a flow chart showing a method for manufacturing a color filter substrate.

FIGS. 5(a) to 5(f) are cross-sectional views schematically showing the method for manufacturing a color filter substrate.

FIG. 6 is a cross-sectional view schematically showing a structure of a liquid crystal display.

FIG. 7 is a plane view schematically showing a pixel of the liquid crystal display

FIG. 8 is a perspective view schematically showing a large-size liquid crystal TV set.

FIGS. 9(a) to 9(f) are cross-sectional views schematically showing a method for manufacturing a color filter substrate according to a modification of the embodiment of the invention

FIGS. 10(a) and (b) are plane views showing an arrangement of color elements according to a modification of the embodiment.

### DESCRIPTION OF EXEMPLARY EMBODIMENTS

Embodiments of the invention will now be described using a color filter substrate provided with an orientation film for vertical orientation and an MVA (Multi-domain Vertical Alignment) liquid crystal display using this color filter substrate, as examples. The drawings to be used for explanation are enlarged or shrunk as necessary to clarify the components.

Color Filter Substrate

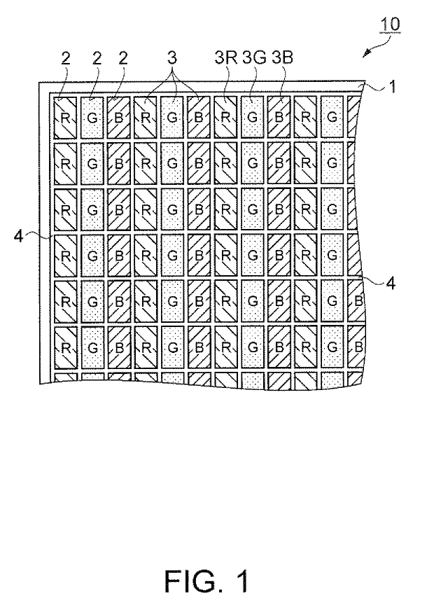

FIG. 1 is a plane view schematically showing a structure of a color filter substrate. A color filter substrate 10 according to this embodiment has a first partition wall 4 surrounding a plurality of color element areas 2 on the surface of a transparent glass substrate 1 serving as a substrate. Each of the color element areas 2 has three colors (R: red, G: green, B: blue) of color elements 3 formed therein. Each of the color elements 3R, 3G, and 3B is arranged in a line with the same color of color elements. That is, the color filter substrate 10 is provided with the color elements 3 in stripes.

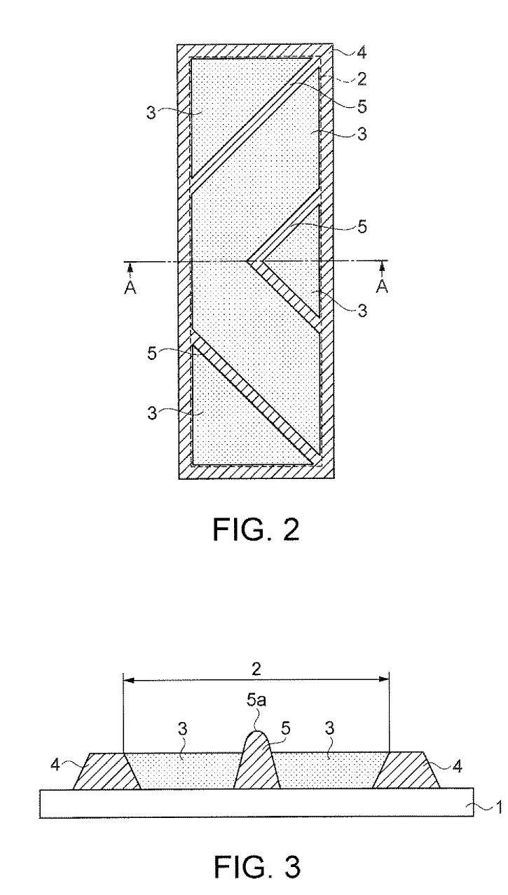

FIG. 2 is an enlarged plane view showing one color element area. The color element area 2 surrounded by a first partition wall 4 includes a second partition wall 5 partitioning the color element area 2 into a plurality of areas. The second partition wall 5 is provided in an elbowed shape so as to partition the color element area 2 at an angle of 45 degrees in the vertical direction of the paper in which the figure is described. The width of the second partition wall 5 depends on the size of the color element area 2 and is typically about 10 micrometers. In the FIG. 2, parts of the second partition wall 5 rest on corners of the first partition wall 4. The position of the second partition wall 5 may be set as necessary depending on the aspect ratio of the color element area 2.

A color element 3 is formed by ejecting three types (colors) of function liquids including different color element forming materials on each plurality of areas formed by partitioning the color element area 2 and then drying the ejected function liquids. As such function liquids, known materials may be used. For example, it is possible to use a function liquid consisting of acrylic resin, polyurethane resin, or the like colored by an inorganic or organic pigment serving as a color element forming material.

FIG. 3 shows a schematic A-A cross-section of the color element area shown in FIG.2. The second partition wall 5 is formed on the glass substrate 1 so as to protrude 1 to 2 micrometers further than the first partition wall 4 in the height direction. The color element 3 is formed so as to have approximately the same film thickness as the first partition wall 4. That is, in the color element area 2, the second partition wall 5 is formed so as to protrude further than the color element 3. The top 5a of the protruding second partition wall 5 is curved; however, the shape of the top 5a is not limited to this and may include a ridge consisting of slopes,

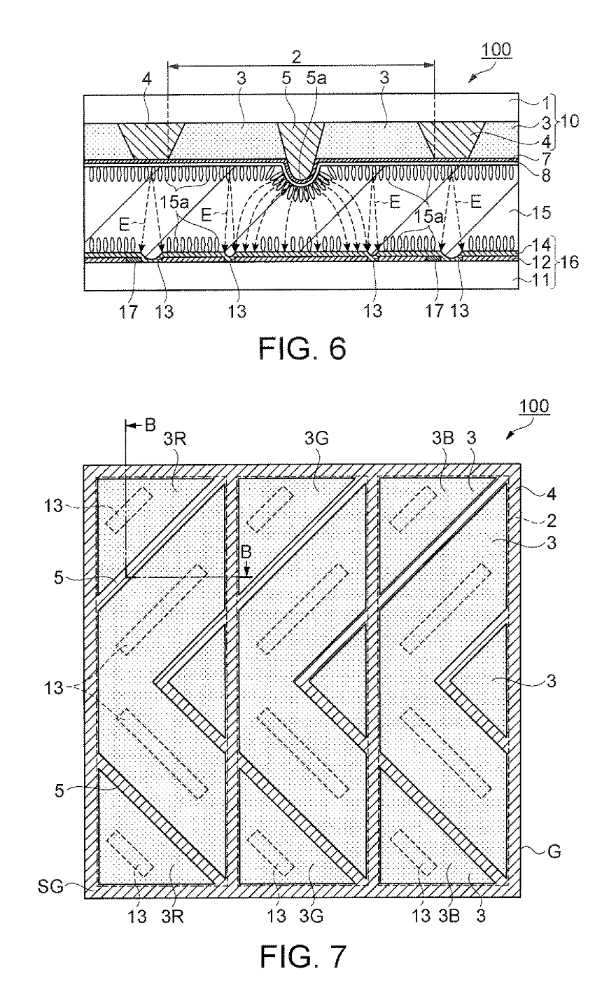

The color filter substrate 10 has a transparent electrode and an orientation film for vertical orientation laminated thereon so as to cover the color element area 2. The second partition wall 5 also serves as a protrusion for orientation control. The color filter substrate 10 is used in an MVA liquid crystal display 100 (refer to FIG. 6) to be discussed later.

Method for Manufacturing a Color Filter Substrate

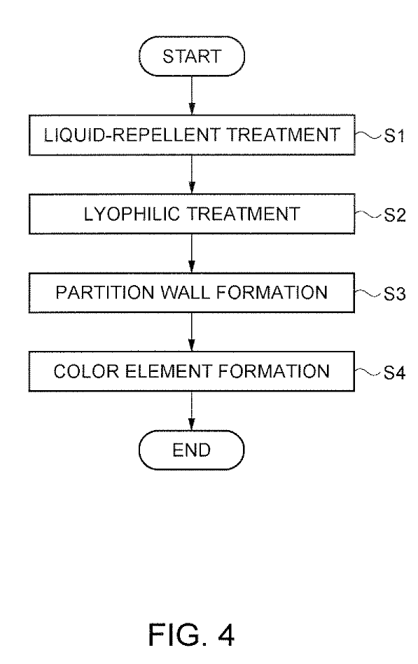

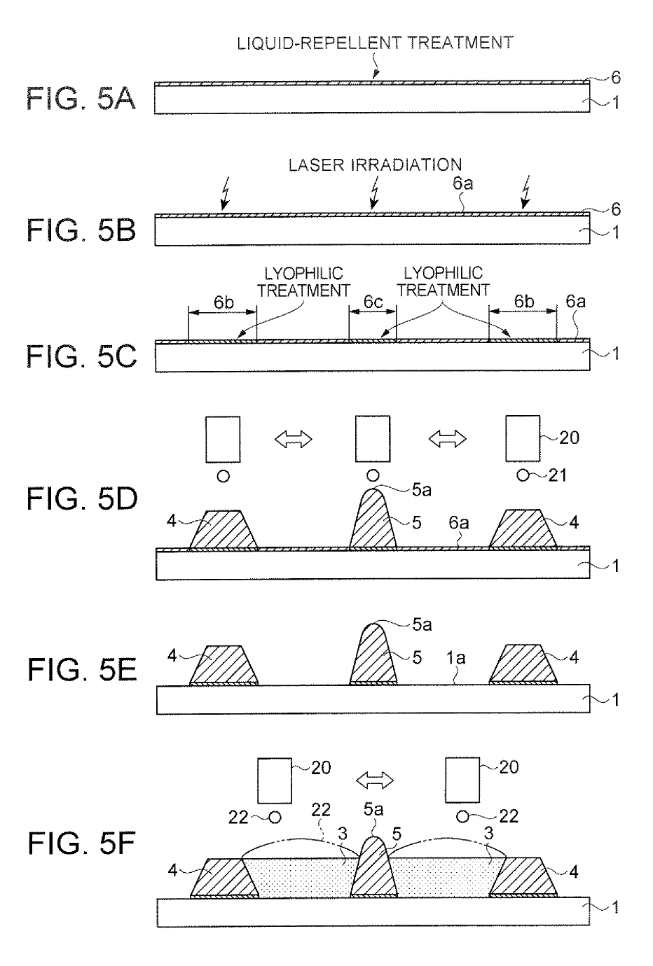

Hereafter, a method for manufacturing a color filter substrate according to the embodiment will be described with reference to FIGS. 4 and 5. FIG. 4 is a flow chart showing the method for manufacturing a color filter substrate, and FIGS. 5 (a) to 5 (f) are cross-sectional views schematically showing the method for manufacturing a color filter substrate

The method for manufacturing the color filter substrate 10 according to the embodiment includes applying i quid repellent treatment to the surface of the glass substrate 1 so that such a surface is liquid repellent (step S1), and applying lyophilic treatment to the surface of the glass substrate 1 subjected to liquid repellent treatment, corresponding to an area in which the first partition wall 4 is formed and an area in which the second partition wall 5 is formed, so that such a surface is lyophilic (step S2). The abovementioned method further includes forming the first partition wall 4 so as to surround the plurality of color element areas 2 on the glass substrate 1 and forming the second partition wall 5 so as to partition each of the plurality of color element areas 2 into a plurality of areas (step S3). The abovementioned method furthermore includes forming plural types of color elements 3 by ejecting three types (colors) of function liquids including different color element forming materials on the plurality of color element areas 2 (step St.).

Step S1 in FIG. 4 is the liquid repellent treatment step. In step S1, as shown in FIG. 5(a), a thin film 6 is formed on the surface of the glass substrate 1 to make the surface liquid repellent. As a method for forming the thin film 6, FAS (fluoroalkylsilane) or HMDS (hexamethyldisilane) is used as a liquid repellent material to form the thin film 6 including an approximately mono molecular film. More specifically, it is possible to use a method in which a self-assembled film is formed on the surface of the glass substrate 1, or the like.

In the self-assembled film forming method, a self-assembled film including an organic molecule film or the like is formed on the surface of the glass substrate 1. The organic molecule film includes a functional group that can be combined with the glass substrate 1, a functional group serving as a liquid repellent group for modifying the surface property (controlling surface energy) on the opposite side, and a straight chain of a carbon or a partially branched carbon chain for bonging these functional groups together. The organic molecule film forms a molecule film, e.g., a monomolecular film by being combined with the glass substrate 1 and carrying out self-assembly.

This self-assembled film includes a combinative functional group that can react to a constituent atom in the base layer or the like of the glass substrate 1 and other straight chain molecules. The self-assembled film is a film formed by orienting a compound that has a very high orientation owing to mutual operation of straight molecules. Since the self-assembled film is formed by orienting a mono-molecule, it is possible to make the film thickness very thin as well as to make the film uniform at the molecule level. That is, since the same molecule is positioned on the film surface, it is possible to provide the film surface with uniform and excellent liquid repellency.

By using, for example, fluoroalkylsilane as the abovementioned compound with high orientation, each compound is oriented so as to position a fluoroalkylsilane group on the film surface, forming a self-assembled film and providing the film surface with uniform liquid repellency. As examples of a compound that forms a self-assembled film, fluoroalkylsilanes such as heptadecafluoro-1,1,2,2-tetrahydrodecyltriethoxysilane, heptadecafluoro-1,1,2,2-tetrahydrodecyltrimethoxysilane, heptadecafluoro-1,1,2,2-tetrahydrodecyltrichlorosilane, tridecafluoro-1,1,2,2-tetrahydrooctyltriethoxysilane, tridecafluoro-1,1,2,2-tetrahydrooctyltrimethoxysilane, tridecafluoro-1,1,2,2-tetrahydrooctyltrichlorosilane, and trifluoropropyltrimethoxysilane can be listed. These compounds may be used solely or in combination of two or more such fluoroalkylsilanes. Use of FSA makes it possible to obtain adhesiveness with the glass substrate 1 as well as excellent liquid repellency.

FAS is typically represented by a constitutional formula, RnSiX(4−n). “n” represents an integer of 1 to 3. X is a hydrolysis group such as methoxy group, ethoxy group, or halogen atom. R is a fluoroalkyl group and has the structure of (CF₃)(CF₂) x (CH₂)y (x represents an integer of 0 to 10, y represents an integer of 0 to 4). When a plurality of R or X is bonded to Si, each R or X may be the same or different. The hydrolysis group represented by X forms a silanol by hydrolysis, reacts to a hydroxyl group in the base layer of the glass substrate 1, and is bonded to the glass substrate 1 by siloxane bond. Since R has a fluoro group such as (CF₂) on its surface, R changes the surface of the base layer of the glass substrate 1 into a non-wettable (surface energy is low) surface.

The self-assembled film including an organic molecule or the like is formed on the glass substrate 1 by containing the abovementioned material compound and the glass substrate 1 in the same container and then leaving them alone at ambient temperature for about 2 to 3 days. Alternatively, maintaining the entire sealed container at a temperature of 100 deg C. allows formation of the self-assembled film on the glass substrate 1 in about three hours. While these are methods for forming the self-assembled film from the gas phase, the self-assembled film can also be formed from the liquid phase. For example, the self-assembled film is formed on the glass substrate 1 by immersing the glass substrate 1 in a solvent including a material compound, and then washing and drying the glass substrate 1. It is preferable that before forming the self-assemble filter, the surface of the glass substrate 1 be subjected to pretreatment such as irradiating an ultraviolet ray on the surface of the glass substrate 1 or washing the substrate with a solvent. Now the manufacturing process proceeds to step S2.

Step S2 in FIG. 4 is the lyophilic treatment step. In step S2, as shown in FIG. 5(b), a lay is irradiated on a surface 6a subjected to liquid repellent treatment so as to make the surface lyophilic. An area in which the lay is irradiated is bonded to a hydroxyl group to be lyophilic owing to the siloxane bond cleaved [symbol] :13 As shown in FIG. 5(c), areas to be subjected to such irradiation are an area 6b in which the first partition wall 4 is formed and an area 6c in which the second partition wall 5 is formed.

The ray to be irradiated is preferably a laser lay having a wavelength band that causes heating, eg., one having a wavelength band in the infrared area (0.7 to 10 micrometers). As a source of such a laser lay, it is possible to use, for example, Nd: YAG laser (1.064 μm), CO₂ laser (10.6 μm), or the like. Using these laser lay sources and a laser irradiation device provided with a table movable in at least the X and Y directions, the lyophilic treatment is applied by placing the glass substrate 1 on the table and irradiating a laser lay as if to draw the areas 6a and 6b on the glass substrate 1.

To apply lyophilic treatment to the thin film 6 including FAS or the like, it is also possible to use a method in which areas of the thin film other than the areas 6b and 6c to be subjected to lyophilic treatment are masked and then the thin film 6 is subjected to UV (ultraviolet ray) irradiation. Then the process proceeds to step S3.

Step S3 in FIG. 4 is the partition wall forming step. In step S3, as shown in FIG. 5(d), a droplet ejection head 20 that can eject a liquid from a nozzle as a droplet is used to eject a function liquid 21 including a partition wall forming material as a droplet to form the first partition wall 4 and the second partition wall

More specifically, the droplet ejection head 20 is positioned so that the head is sequentially opposed to the area 6a in which the first partition wall 4 is formed and the area 6c in which the second partition wall 5 is formed Then the droplet ejection head 20 ejects the function liquid 21 as a droplet, make the liquid land, and wets, and spreads on, the relevant areas. Repeating this step and a step of drying the ejected function liquid 21 allows deposition of the function liquid 21, forming the first partition wall 4 and the second partition wall 5. The second partition wall 5 is formed by ejecting the function liquid 21 so that the second partition wall 5 protrudes 1 to 2 micrometers further than the first partition wall 4 in the height direction. Typically the height of the first partition wall 4 is approximately 1.5 micrometers and that of the second partition wall 5 is approximately 2.5 micrometers. The second partition wall 5, whose width is 10 micrometers, is raised by surface tension after the function liquid 21 lands and, after dried, its top 5a is curved. As the function liquid 21, it is possible to use a solution including a phenol resin or the like as a partition wall forming material. Then the process proceeds to step S4.

Step S4. in FIG. 4 is the color element forming step. In step S4., as shown in FIG. 5(e), a step of eliminating the thin film 6 remaining on the glass substrate 1 on which the first partition wall 4 and the second partition wall 5 are formed is carried out. The thin film 6 is a mono molecular film including FAS or the like and can be eliminated by heating and the glass substrate 1 up to a temperature of approximately 300 deg C. and thus subliming it. It is also possible to make a surface 1a of the glass substrate 1 lyophilic after eliminating the thin film 6. As a method for eliminating the thin film 6 other than heating, UV irradiation, O₂ plasma treatment, or the like can be used.

Then, as shown in FIG. 5(f) a color element 3 is formed by ejecting a function liquid 22 including a color element forming material from the droplet ejection head 20 as a droplet onto each plurality of areas formed by partitioning the color element area 2 by the second partition wall 5, and then drying the elected function liquid 22. As a matter of course, the droplet ejection head 20 is sequentially filled with three types of function liquids 22 including different color element materials respectively corresponding to the color element areas 2 in which different colors of color elements 3R, 3G and 3B are formed, and ejects such function liquids. Alternatively, it is possible to prepare a plurality of droplet ejection heads 20, to fill the plurality of droplet ejection heads 20 with the function liquids 22 including different color element materials, and to eject such function liquids.

In this case, the function liquid 22 is ejected while adjusting the frequency of ejecting the function liquid 22 for each plurality of areas formed by partitioning the color element area 2 by the second partition wall 5 so that the film thickness of the color element 3 after dried is approximately the same as the height of the first partition wall 4 (approximately 1.5 micrometers). By doing this, the second partition wall 5 protrudes approximately one micrometer from the surface of the formed color element 3 and serves as a protrusion for orientation control.

Liquid Crystal Display

Hereafter, a liquid crystal display according to the embodiment will be described with reference to FIGS. 6 and 7. FIG. 6 is a cross-sectional view schematically showing the structure of a liquid crystal display, and FIG. 7 is a plane view schematically showing a pixel of the liquid crystal display. More specifically, FIG. 6 is a schematic B-B cross-sectional view of the liquid crystal display shown in FIG. 7. FIG. 7 is an enlarged view of the pixel seen from the color filter substrate 10.

As shown in FIG. 6, a liquid crystal display 100 according to the embodiment includes a color filter substrate 10 having three colors of color elements 3, a device substrate 16 serving as an opposite substrate, in which a plurality of electrodes 12 respectively corresponding to the color elements 3 are formed on a transparent substrate. The liquid crystal display 100 also includes a liquid crystal 15 having a negative dielectric constant, sandwiched between the color filter substrate 10 and the device substrate 16. The color filter substrate 10 has thereon the first partition wall 4 surrounding the color element area 2 in which the color elements 3 are formed and the second partition wall 5 partitioning the color element area 2 into a plurality of areas. Further, a common electrode 7 consisting of a transparent ITO (Indium Tin Oxide) is formed so as to cover the color element 3, the first partition wall 4, and the second partition wall 5. The device substrate 16 is provided with a TFT (Thin Film Transistor) device 17 serving as a switching device for providing a driving potential to a pixel electrode 12. The surfaces of the color filter substrate 10 and the device substrate 16 facing the liquid crystal 15 are provided with orientation films 8 and 14, respectively, for orienting a molecule of the liquid crystal 15 approximately perpendicularly to the surfaces.

Such a liquid crystal display 100 is intended to visually recognize information such as image displayed from the side of the color filter substrate 10. A polarizing plate (not shown) is provided on the surface of the color filter substrate 10 and on the back of the device substrate 16. A lighting device (now shown) having a light source such as cold cathode or LED is provided on the back of the device substrate 16 and illuminates the liquid crystal display 100.

As shown in FIGS. 6 and 7, the liquid crystal display 100 has a plurality of sub-pixels SG for display, and one pixel G consists of three sub-pixels SG corresponding to three colors of color elements 3R, 3G, and 3B. The second partition wall 5 provided on each sub-pixel SG is formed so as to protrude from the surface of the color element 3, and serves as a protrusion for orientation control. A pixel electrode 12 opposed to the color element 3 is provide with a plurality of slits 13 serving as an aperture opening toward the color filter substrate 10 in parallel with the second partition wall 5.

FIG. 6 shows a state of the liquid crystal display 100 in which no drive voltage is applied to the liquid crystal display 100. In this case, a molecule 15 of the liquid crystal 15 to be oriented on the second partition wall 5 protruding from the surface of the color element 3 is oriented approximately perpendicularly to the curved surface of the top 5a. When a drive voltage is applied between the common electrode 7 of the color filter substrate 10 and a pixel electrode 12 of the device substrate 16, an electric field E in a slanting direction is generated between the top 5a and the pixel electrode 12 as well as between the common electrode 7 in the areas other than the top 5a and the slit 13. The molecule 15a of the liquid crystal 15 falls so as to be perpendicular to the direction of the electric field E. Thus, when a drive voltage is applied with the top 5a and the slit 13 used as borders, areas are formed in which the molecule 15a of the liquid crystal 15 falls in different directions. That is, the color element area 2 partitioned into a plurality of areas by the second partition wall 5 and subjected to orientation control has different viewing angle dependencies. This makes it possible to provide the liquid crystal display 100 that has a wide viewing angle as a viewing angle characteristic.

Method For Manufacturing a Liquid Crystal Display

A method for manufacturing the liquid crystal display 100 according to the embodiment includes using the color filter substrate 10 that has the manufacturing process of forming a protrusion for orientation control that can be simplified and has the uniform color elements 3 in the color element area 2. This allows manufacture of the liquid crystal display 100 with higher efficiency, reduced faults such as color unevenness, and improved yield.

Known methods may be used to form the transparent substrate 11, the TFT device 17, a wiring for electrically connecting those, and so on as well as to bond the color filter substrate 10 and the device substrate 16 together in a predetermined position using an adhesive or the like, and then to fill the clearance with the liquid crystal 15. To form the orientation films 8 and 14 for vertical orientation on the respective surfaces of the color filter substrate 10 and the device substrate 16 facing the liquid crystal 15, a method is used which the orientation films are formed by adding a solvent to an organic compound such as soluble polyimide, polyamic acid type polyimide, and modified polyimide serving as an orientation film material to adjust the viscosity and then printing the solvent-added compound by offset or the like or ejecting it by the liquid ejecting method.

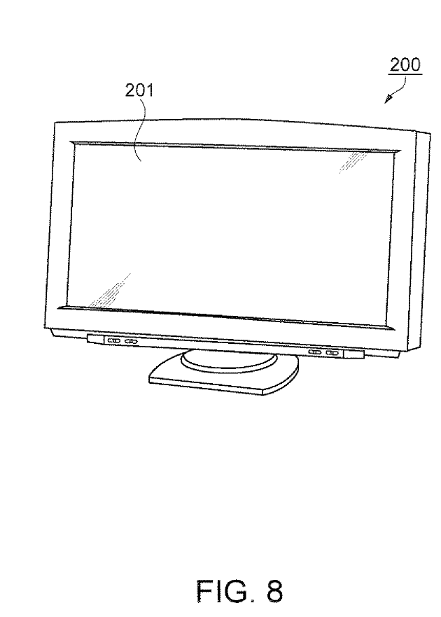

A large-scale liquid crystal TV set serving as an electronic device according to the embodiment will now be described. FIG. 8 is a perspective view schematically showing a large-scale TV set. The large-scale TV set 200 includes the liquid crystal display 100 having a wide viewing angle as a viewing angle characteristic according to the abovementioned embodiment, in the display unit 201. Since it is possible to manufacture the liquid crystal display 100 with higher efficiency, reduced faults such as color unevenness, and improved yield, it is possible to achieve the large-scale liquid crystal TV set 200 that has excellent display quality as well as high cost-performance.

Advantages of the abovementioned embodiment are as follows.

1. The color filter substrate 10 according to the embodiment has the second partition wall 5 thereon that partitions each of the plurality of color element areas 2, surrounded by the first partition wall 4, into plurality of areas. The second partition wall 5 is formed so as to protrude from the color elements 3 formed on the color element area 2, and also serves as a protrusion for orientation control. Therefore, unlike in a case in which the second partition wall 5 is not provided, it is possible to form the color elements 3 on every plurality of areas, which are formed by partitioning the color element area 2 and are made narrower than the color element area 2. This makes it easy to even the color elements 3 to be formed. Thus, it is possible to provide the color filter substrate 10 that has the manufacturing process of a protrusion for orientation control that can be simplified as well as has the uniform color elements 3 in the color element area 2. In addition, a reduction of the area in which the color elements 3 are formed allows a reduction in waste of the color element forming material.

2. In the color filter substrate 10 and the manufacturing method thereof according to the embodiment, three colors of the color elements 3R, 3G, and 3B, formed on the plurality of color element areas 2, are formed by ejecting the function liquid 22 including a color element forming material. Therefore, since the function liquid 22 is ejected onto every plurality of areas that are formed by partitioning the color element area 2 and are made smaller, it is possible to fill the function liquid 22 with every plurality of areas to form the color elements 3 having a uniform film thickness and evenness. This is, it is possible to reduce faults such as dropout or color unevenness due to the color element area 2 not filled with the function liquid 22.

3. In the color filter substrate 10 and the manufacturing method thereof according to the abovementioned embodiment, repetition of the step of ejecting the function liquid 21 including a partition wall forming material onto the area 6c of the glass substrate 1 subjected to lyophilic treatment by irradiating a laser ray and then drying the ejected liquid allows accumulation of the landing function liquid 21 and formation of the top 5a in a curved shape. Therefore, it is possible to form the second partition wall 5 having a narrow width of approximately 10 micrometers. The color element 3 is formed in approximately the same film thickness (1.5 micrometer) as the height of the first partition wall 4, and the second partition wall 5 is formed to be 1 micrometer higher than the first partition wall 4. For these reasons, formation of an orientation film for vertical orientation on the surface of the glass substrate 1 so as to cover the second partition wall 5 allows partition of the interior of the color element area 2 into different plural orientation control areas with the top 5a of the second partition wall 5 used as a border, without causing unevenness of the orientation film surface on the border between the first partition wall 4 and the color element 3.

4. In the method for manufacturing the color filter substrate 10 according to the abovementioned embodiment, all of the first partition wall 4, the second partition wall 5, and the three types (colors) of color elements 3R, 3G, and 3B are formed using the droplet ejection method in which the function liquid is ejected as a droplet from a nozzle of the droplet ejection head 20. For this reason, unlike in a case in which these components are formed by photolithography, there is no need to prepare facilities for coating, exposure, development, and washing of the photosensitive material for the manufacturing process of each component.

5. The color filter substrate 10 and the manufacturing method thereof according to the abovementioned embodiment is configured or manufactured using the color filter substrate 10 that has the manufacturing process of a protrusion for orientation control that can be simplified as well as has the uniform color elements 3 in the color element area 2. This makes it possible to provide the liquid crystal display 100 that has a wide viewing angle as a viewing angle characteristic. This also allows manufacture of the liquid crystal display 100 with higher efficiency, reduced faults such as color unevenness, and improved yield.

6. A large-scale liquid crystal TV set 200 serving as an electronic device according to the abovementioned embodiment includes the liquid crystal display 100 according to the embodiment, in the display unit 201. This makes it possible to provide the large-scale liquid crystal TV set 200 that has excellent display quality of a wide viewing angle and less color unevenness as well as high cost-performance.

Modifications of the abovementioned embodiment are as follows.

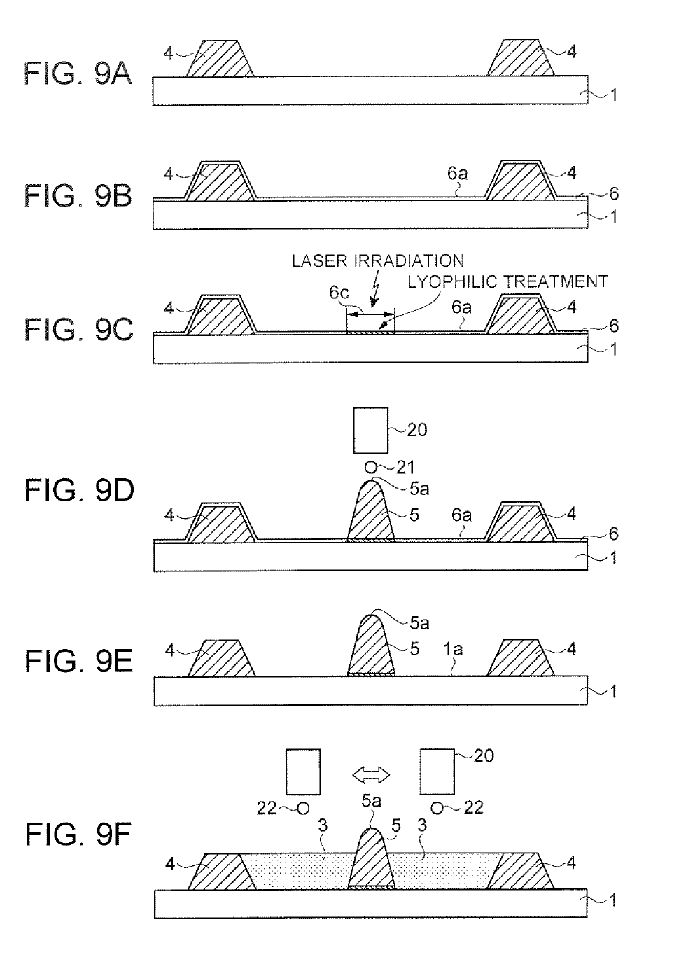

Modification 1. In the method for manufacturing the color filter substrate 10 according to the embodiment, the method for forming the first partition wall 4 is not limited to this. FIGS. 9(a) to 9(f) are cross-sectional views schematically showing a method for manufacturing a color filter substrate according to a modification of the embodiment. As shown in FIG. 9(a), for example, the first partition wall 4 is first formed on the glass substrate 1. In this case, the first partition wall 4 is formed by coating the surface of the glass substrate 1 with a photosensitive resin so that the film thickness is approximately 1.5 micrometers It is preferable that the photosensitive resin include a black pigment and be lightproof. Then, shown in FIG. 9(b), the thin film 6 for making the surface of the glass substrate 1, on which the first partition wall 4 is formed, liquid repellent is formed. Then, as shown in FIG. 9(c), the area 6c of the surface 6a subjected to liquid repellent treatment on which the second partition wall 5 is to be formed is subjected to laser irradiation so as to be lyophilic. Then, as shown in FIG. 9(d), the function liquid 21 including a partition wall forming material is ejected from the droplet ejection head 20 to form the second partition wall 5. Then, as shown in FIG. 9(e), the liquid repellent thin film 6 is eliminated by heating or the like. Then, as shown in FIG. 9(f) the function liquid 22 including a partition wall forming material is ejected from the droplet election head 20 onto the color element area 2 surrounded by the first partition wall 4 and partitioned by the second partition wall 5 to form a color element 3. In this way, the color element area 2 corresponding to a sub-pixel SG can be partitioned and formed in a stable shape. Further, when configuring or manufacturing the liquid crystal display 100 using the color filter substrate 10 manufactured in such a manner, it is possible to prevent light leakage between the sub-pixels SG to display an image clearly thanks to the formed first partition wall 4 being lightproof.

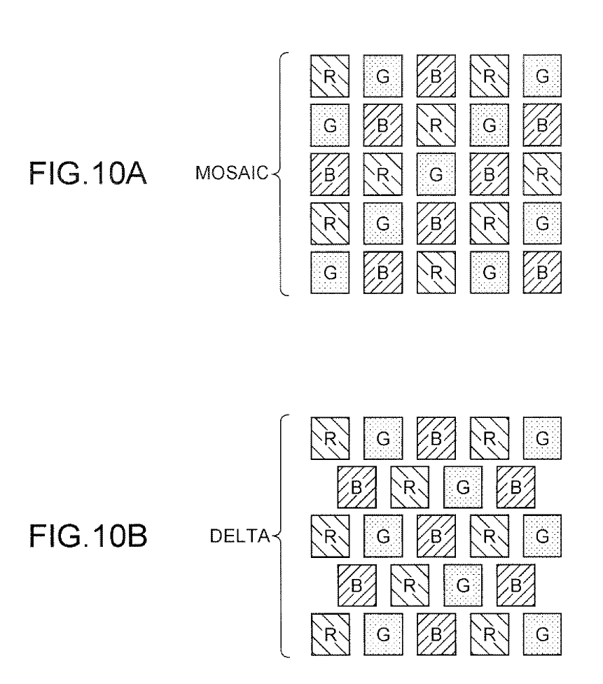

Modification 2. In the color filter substrate 10 according to the embodiment, the configuration of the color elements 3 is not limited to this. For example, the arrangement order of the three colors of the color elements 3R, 3G, and 3B may be different. FIGS. 10(a) and 10(b) are plane views showing an arrangement of color elements according to a modification. The invention can also be applied to a mosaic style in which the same color of color elements 3 are arranged in a slanting direction, as shown in FIG. 10(a), and a delta style in which different colors of color elements 3 are each arranged at the vertex of a triangle, as shown in FIG. 10(b). Further, the color element 3 is not limited to three colors and may consist of four colors to which another color is added to enhance color reproducibility.

Modification 3. In the liquid crystal display 100 and the manufacturing method thereof according to the embodiment, the arrangement of the common electrode 7 of the color filter substrate 10 is not limited to this. For example, the common electrode 7 may be formed by conducting masking so as to avoid the top 5a of the second partition wall 5. According to this modification, even when the clearance between the color filter substrate 10 and the device substrate 16 to be filled with the liquid crystal 15 becomes very narrow, no common electrode 7 is present at the top 5a of the protruding second partition wall 5. This makes it possible to reduce faults of short-circuits between the common electrode 7 and the pixel electrode 12.

Modification 4. The electronic device on which the liquid crystal display 100 according to the embodiment is installed is not limited to the large-scale liquid crystal TV set 200. For example, the liquid crystal display 100 can preferably be used as an image display means for portable information devices or portable terminal devices called PDA (Personal Digital Assistants), personal computers, word processors, digital still cameras, in-car monitors, digital video recorders with a direct-view monitor, car navigation systems, electronic notebooks, workstations, picturephones, POS terminals, and the like.

What is claimed is:

1. A color filer substrate composing a liquid crystal display by sandwiching a liquid crystal with an opposite substrate having a plurality of pixel electrodes, comprising:
a first partition wall surrounding a plurality of color element areas on the color filter substrate;
a second partition wall partitioning each of the plurality of color element areas into a plurality of areas; and
a plurality of color elements formed in the plurality of color element areas,
wherein the second partition wall is formed so as to protrude further than the color element in the height direction and the protruding portion also serves as a protrusion for controlling the orientation of a molecule of the liquid crystal.

2. The color filter substrate according to claim 1, wherein the color element is formed by ejecting a function liquid including a color element forming material onto the color element area.

3. The color filter substrate according to claim 1, wherein the second partition wall is formed so as to be 1 to 2 micrometers higher than the first partition wall and the color element has approximately the same film thickness as that of the first partition wall.

4. The color filter substrate according to claim 1, wherein the top of the second partition wall is curved.

5. A liquid crystal display, comprising:
a color filter substrate according to claim 1;
an opposite substrate having a plurality of pixel electrodes corresponding to the plurality of color element areas on the color filter substrate; and
a liquid crystal sandwiched between the color filter substrate and the opposite substrate,
wherein the respective surfaces of the color filter substrate and the opposite substrate facing the liquid crystal are provided with an orientation film for orienting the molecule of the liquid crystal approximately perpendicular to the respective surfaces.

6. The liquid crystal display according to claim 5, wherein the pixel electrode is provided with an aperture opening toward the color filter substrate in parallel with the second partition wall in positions corresponding to the plurality of areas formed by partitioning each of the plurality of color element areas by the second partition wall.

7. An electronic device, wherein the liquid crystal display according to claim 5 is installed.

8. A method for manufacturing a color filter substrate having plural types of color elements in a plurality of color element areas surrounded on a substrate, comprising:
forming a first partition wall so that the first partition wall surrounds the plurality of color element areas on the substrate;
forming a second partition wall so that the second partition wall partitions each of the plurality of color element areas into a plurality of areas; and
forming plural types of color elements by ejecting plural types of function liquids including different color element forming materials onto the plurality of color element areas,
wherein in the second partition wall forming step, the second partition wall is formed so as to protrude further than the first partition wall in the height direction.

9. The method for manufacturing a color filter substrate according to claim 8, wherein in the color element forming step, the function liquids are ejected so that the first partition wall and the color elements have approximately the same film thickness.

10. The method for manufacturing a color filter substrate according to claim 8, further comprising:
applying liquid repellent treatment to the substrate surface so that the substrate surface is liquid repellent; and
applying lyophilic treatment to the substrate surface subjected to liquid repellent treatment, corresponding to an area in which the first partition wall is formed and an area in which the second partition wall is formed, so that such a substrate surface is lyophilic,
wherein in the first partition wall forming step and the second partition wall forming step, the first partition wall and the second partition wall are formed by ejecting a function liquid including a partition wall forming material onto the substrate surface subjected to lyophilic treatment.

11. The method for manufacturing a color filter substrate according to claim 8, further comprising:
applying liquid repellent treatment to the substrate surface on which the first partition wall is formed so that such a surface is liquid repellent; and
applying lyophilic treatment to the substrate surface subjected to liquid repellent treatment, corresponding to the area in which the second partition wall is formed, so that such a surface is lyophilic,
wherein in the second partition wall forming step, the second partition wall is formed by ejecting a function liquid including a partition wall forming material onto the substrate surface subjected to lyophilic treatment.

12. The method for manufacturing a color filter substrate according to claim 10, wherein in the liquid repellent treatment step, a liquid repellent thin film is formed on the substrate surface, and in the color element forming step, at least the thin film remaining in the color element area is eliminated.

13. The method for manufacturing a color filter substrate according to claim 10, wherein in the lyophilic treatment step, at least the substrate surface subjected to liquid repellent treatment, corresponding to the area in which the second partition wall is formed is irradiated with a ray so as to be lyophilic.

14. A method for manufacturing a liquid crystal display including a color filter substrate having plural types of color elements, an opposite substrate having a plurality of pixel electrodes corresponding to the plural types of color elements, a liquid crystal sandwiched between the color filter substrate and the opposite substrate, and an orientation film provided on the respective surfaces of the color filter substrate and the opposite substrate facing the liquid crystal for orienting a molecule of the liquid crystal approximately perpendicular to the respective surfaces, wherein the color filter substrate is manufactured using the method for manufacturing a color filter substrate according to claim 8.
